(19) United States
(12) Patent Application Publication
(10) Pub. No.: US 2011/0251867 A1
(43) Pub. Date: Oct. 13, 2011

(54) METHOD AND SYSTEM FOR INTEGRATED OPERATIONS AND SERVICE SUPPORT

(75) Inventors: Rahul Madhusudan Joshi, Hyderabad (IN); Vivek Krishnan, Bangalore (IN); Gopi Krishna Chilukamarri, Hyderabad (IN); Manasa Juvvadi, Godavarikhani (IN); Himabindu Donepudi, Hyderabad (IN)

(73) Assignee: INFOSYS TECHNOLOGIES LIMITED, Bangalore (IN)

(21) Appl. No.: 12/813,682

(22) Filed: Jun. 11, 2010

(30) Foreign Application Priority Data
Apr. 9, 2010 (IN) 977/CHE/2010

(51) Int. Cl. G06Q 10/00; G06F 17/30; G06F 3/048

(52) U.S. Cl. 705/7.13; 715/772; 707/769; 707/E17.014

(57) ABSTRACT

A method, system, and computer program product for initiating a plurality of incident and service requests are provided. Outages are checked corresponding to the incident and service requests. If the outages exist, they are displayed and mapped to the incident and service requests. If the outages do not exist, they are created if required and mapped corresponding to the incident and service requests. The incident and service requests are assigned to users available in a shift for solutions. If the solutions corresponding to the incident and service requests exist in a knowledge database, they are implemented. If the solutions corresponding to the incident and service requests do not exist in the knowledge database, they are created by the users available in the shift. Various checks are performed based on a checklist prior to the closure of the incident and service requests.

### BACKGROUND OF THE INVENTION

The invention relates generally to the field of information technology service management (ITSM). More specifically, the invention relates to a method and system for providing integrated operations and service support.

Several technologies have been developed to implement information technology infrastructure library (ITIL)-aligned service management processes. An interesting use of this technology is to provide seamless workflow automation within and across key ITIL processes, resulting in rapid organizational adoption and process efficiency. However, current tools implementing the ITIL processes have certain limitations that pose challenges in operations of infrastructure management processes. There is a limited integration between individual processes, as implemented in the current tools.

There are several limitations in the implementation of a configuration database. The focus in the configuration database is on servers, and less on applications. There are technical issues related to data integrity of the configuration database. A lot of inconsistencies are caused in the ITIL processes due to delay in configuration database updates in the current tools.

In the existing scenario, knowledge management is an independent activity in the ITIL that adds to the overhead. The integration between the knowledge management and incident management is limited. As a result, solution update becomes an overhead when there is a high request flow.

Existing tools offer no integration of the shift management with the incident management. This often brings up cases of invisibility of domain experts when there are critical issues. Hence, there is a lack of timely alerts and notifications to support teams in cases of high impact incidents.

Also, there is no integration of monitoring solutions with the incident management. There exists no Service Level Agreement (SLA) dashboard for engineers and shift leads. The reporting mechanism for tracking performance of queues, SLA adherence, and effort is insufficient in the existing technologies.

Hence, there exists a need for an integrated platform to address all the above limitations. There should be a method and system for implementing and adhering to the ITIL processes in the infrastructure management space. Further, the method and system should be the best fit for all customers who wish to organize the management of an incident, configuration, knowledge, shift, outage, and various other management processes integrated in a single product.

### BRIEF SUMMARY OF THE INVENTION

The invention provides a method, system and computer program product for processing a plurality of incident and service requests. First, the incident and service requests are initiated. The outages are checked corresponding to the incident and service requests. If the outages exist, they are displayed and mapped to the incident and service requests.

Once the outages are checked, the incident and service requests are assigned to users available in a shift for solutions. If the solutions corresponding to the incident and service requests exist in a knowledge database, they are implemented by the users. If the solutions do not exist in the knowledge database, they are created by the users available in the shift. Thereafter, the created solutions are published or flagged after they are reviewed by a domain expert. Various checks are performed based on a checklist prior to the closure of the incident and service requests.

The method, system and computer program product described above have a number of advantages. The method provides an integration of incident, configuration, knowledge, shift, outage, and various other management processes. It also provides extensive reporting feature with custom reports generation implemented based on user roles. Further, the method improves the efficiency and turnaround time of the execution of ITIL processes with the help of integrated knowledge and configuration databases.

### BRIEF DESCRIPTION OF THE DRAWINGS

Various embodiments of the invention will hereinafter be described in conjunction with the appended drawings, provided to illustrate, and not to limit, the invention, wherein like designations denote like elements, and in which

FIG. 1 illustrates an exemplary environment in which various embodiments of the present invention may be practiced;

FIG. 2 is a flow diagram illustrating a method for processing a plurality of incident and service requests, in accordance with an embodiment of the invention;

FIG. 3 is a flow diagram illustrating a method for initiating the incident and service requests, in accordance with an embodiment of the invention;

FIG. 4 is a flow diagram illustrating a method for checking one or more outages corresponding to the incident and service requests, in accordance with an embodiment of the invention;

FIG. 5 is a flow diagram illustrating a method for assigning the incident and service requests to one or more users available in a shift, in accordance with an embodiment of the invention;

FIG. 6 is a flow diagram illustrating a method for implementing a plurality of solutions corresponding to the incident and service requests, in accordance with an embodiment of the invention;

FIG. 7 illustrates a block diagram of an integrated operations and service support system, in accordance with an embodiment of the invention;

FIG. 8 illustrates a block diagram of an initiating module, in accordance with an embodiment of the invention;

FIG. 9 illustrates a block diagram of an outage module, in accordance with an embodiment of the invention;

FIG. 10 illustrates a block diagram of an assigning module, in accordance with an embodiment of the invention;

FIG. 11 illustrates a block diagram of an implementing module, in accordance with an embodiment of the invention; and

FIG. 12 illustrates a block diagram of a solution provider, in accordance with an embodiment of the invention.

### DETAILED DESCRIPTION

Various embodiments of the present invention relate to a method, system and computer program product for processing a plurality of incident and service requests. Firstly, incident and service requests are initiated. An initiation refers to the creation of tickets corresponding to the incident and service requests. During the initiation, parameters are selected corresponding to the incident and service requests. Thereafter, one or more configurations from a configuration database are mapped to selected parameters.

The configuration database is based on an application instead of a server. The configuration database is metadata-based database. The configuration database maintains Configuration Item (CI) to ensure tight integration with other processes. The CI includes three layers pertaining to application, version, and deployment. Application layer includes configuration fields pertaining to information about the application and application contacts. Version layer includes information related to the version such as version number, development vendor, dependencies, technologies, and the like. Deployment layer includes information related to deployment such as server information, database information, maintenance window, and the like.

Once the incident and service requests have been initiated, outages are checked corresponding to the incident and service requests. If the outages are present, they are displayed, else the outages are created if required. When the outages are created, outage notifications are sent to all application users.

Prior to the assignment of the incident and service requests for solutions, one or more Service Level Agreement (SLA) values are calculated corresponding to the incident and service requests. Reports are generated based on the calculated SLA values.

Once the outages are checked, the incident and service requests are assigned to users available in a shift to find solutions. The solutions are retrieved from a knowledge database if the solutions exist corresponding to the incident and service requests, else the solutions are created by the users available in the shift.

The solutions created by the users available in the shift are reviewed by a domain expert. If the solutions are approved by the domain expert, they are published, else they are flagged. Thereafter, a number of checks are performed based on a checklist for closing the incident and service requests.

The knowledge database is built into Integrated Operations and Service Support System (IOS³). The knowledge database is modeled on the principles of Knowledge Centered Support (KCS) process. KCS is a methodology and a set of processes that focus on knowledge as a key asset of customer/technical support organization. Similarly, the knowledge database integrated with the application focuses on knowledge for solving problems. The solutions are retrieved from the knowledge database if the solutions exist, else the solutions created by the users are updated in the knowledge database. This expedites the process and decreases the turnaround time for providing the solutions.

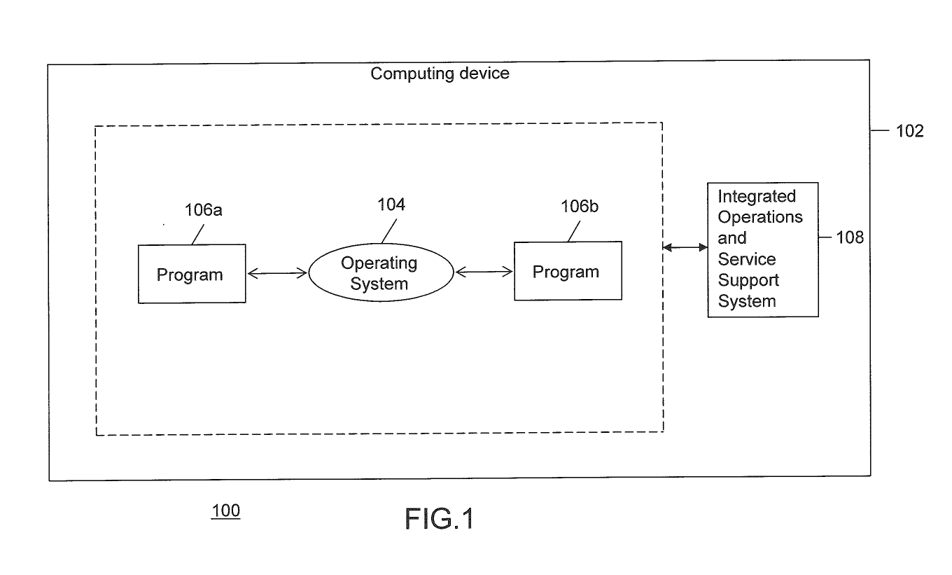

FIG. 1 is a block diagram illustrating an environment 100 used to run an application program in a computing device. Environment 100 includes a computing device 102. Computing device 102 includes an operating system 104, two programs 106a and 106b, and an Integrated Operations and Service Support System (IOS³) 108. Operating system 104 is being used for managing hardware and software resources of computing device 102. Two programs 106a and 106b are being executed on operating system 104. IOS³ 108 is also an application program, running on operating system 104 similar to two programs 106a and 106b. Examples of computing device 102 include, but are not limited to, personal computers, mobile phones, and handheld devices. The functions of operating system 104 include, but are not limited to, controlling and allocating memory, prioritizing system requests, and controlling input and output devices of computing device 102. Examples of operating system 104 include, but are not limited to, Windows®, Linux®, and Mac OS®.

A person ordinarily skilled in the art will understand that the number of programs 106 is not limited to two, but has been assumed so for the exemplary purpose of explaining the invention.

IOS³ 108 includes various modules for implementing ITIL-aligned service management processes to facilitate integrated operations and service support in accordance with an embodiment of the invention. Various modules of IOS³ 108 provide a method and system for processing the incident and service requests. IOS³ 108 has been described in detail in the description of subsequent figures.

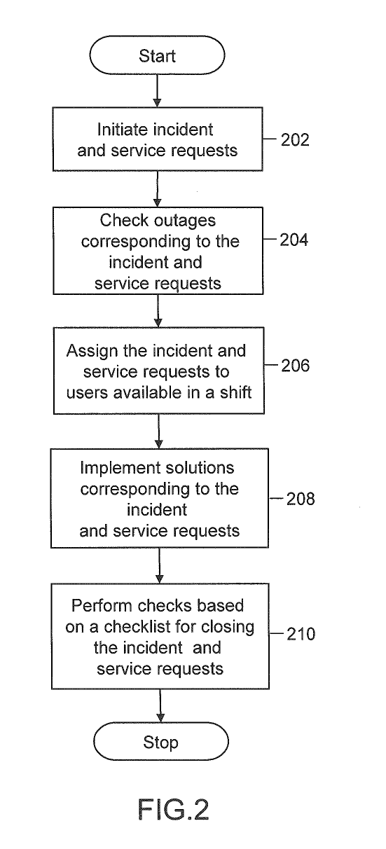

FIG. 2 is a flow diagram illustrating a method for processing the plurality of incident and service requests, in accordance with an embodiment of the present invention. IOS³, referred as IOS³ 108 in FIG. 1, performs the method with the help of various modules for implementing ITIL-aligned service management processes.

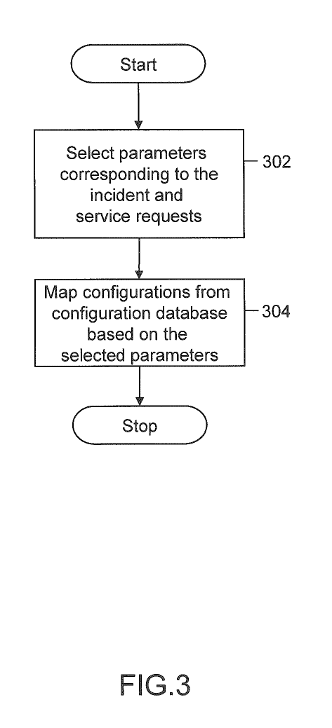

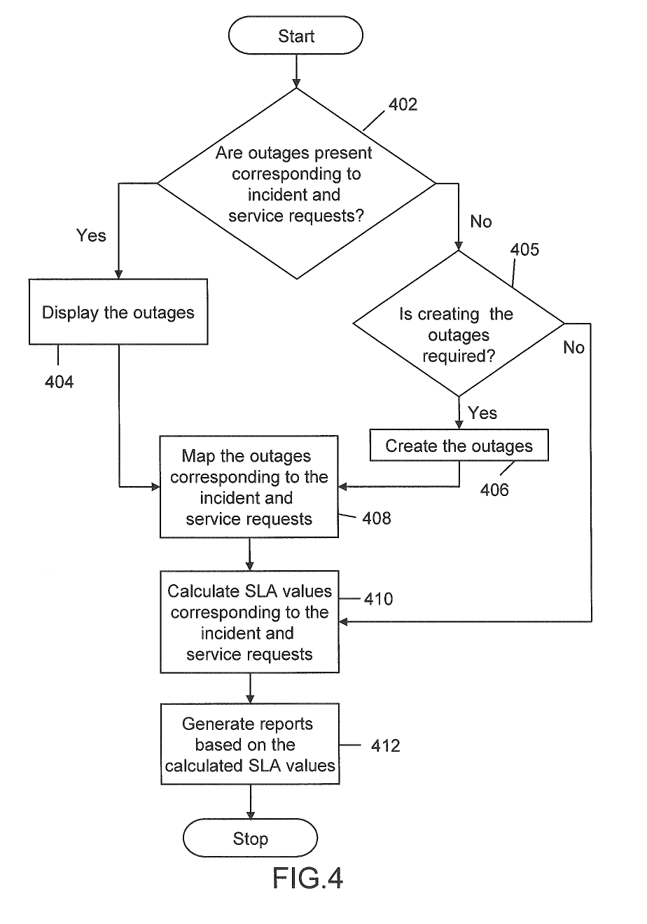

At 202, the incident and service requests are initiated. For example, when a user logs on to IOS³, the user is given the option to search and create an incident and service request. The process of initiating the incident and service requests is described in detail in conjunction with FIG. 3. Once the incident and service requests have been initiated, outages are checked corresponding to the incident and service requests at 204. An outage is raised when a server or application fails to perform its primary function. The outages are tracked to alert a user whenever the user tries to initiate an incident on an application on which the outages are present. The process of checking outages corresponding to the incident and service requests is described in detail in conjunction with FIG. 4.

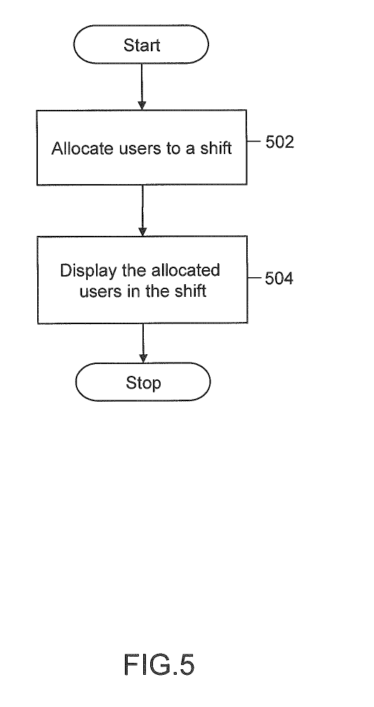

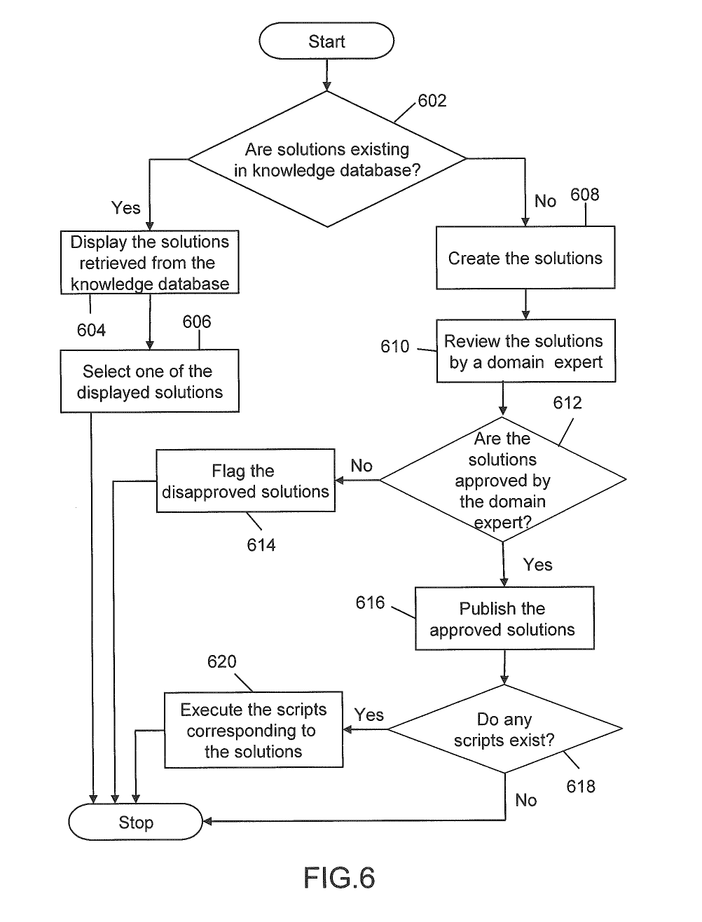

At 206, the incident and service requests are assigned to users available in a shift. The shift is a defined span of time in which the users are available. For example, a user may be in a shift from 9:00 am to 3:00 pm, while another user may be in a shift from 3:00 pm to 9:00 pm. Shifts are defined in such a manner that one or more users are always available at any point of time. A plurality of solutions is provided by the assigned users in the shift if required. The process of assigning the incident and service requests to the users in the shift is described in detail in conjunction with FIG. 5. At 208, the solutions are implemented corresponding to the incident and service requests. The solutions are either retrieved from Knowledge Database 714 if they exist, else they are created by the users available in the shift. The process of implementing the solutions corresponding to the incident and service requests is described in detail in conjunction with FIG. 6.

At 210, various checks are performed based on a checklist prior to closing the incident and service requests. The checklist helps to ensure less human errors occurrences during the resolution process and prior to the closure process. Examples of checks include, but are not limited to, sending notifications to application users, generating reports, and updating connected databases. Prior to the closure of the incident and service requests, Knowledge Database 714 is updated to ensure whether all solutions are captured. The updated Knowledge Database 714 ensures that the time spent for the resolution of similar incident and service requests is reduced in the future.

FIG. 3 is a flow diagram illustrating the detailed steps of the process of initiating the plurality of incident and service requests. At 302, various parameters are selected corresponding to the incident and service requests. Examples of parameters include, but are not limited to, an application name, a version number, a deployment identification number, and a ticket category. A user has to select the abovementioned parameters to initiate an incident and service request. The parameters are hereinafter referred to as CI.

At 304, the CI is mapped to various configurations from Configuration Database 712 based on the CI selected by the user. Examples of configurations include, but are not limited to, a plurality of queues, a Service Level Agreement (SLA), a ticket category mapping, and a domain expert.

FIG. 4 is a flow diagram illustrating the detailed steps of the process of checking the outages corresponding to the plurality of incident and service requests. At 402, outages corresponding to the incident and service requests are checked. If the outages are present, they are displayed at 404. If the outages are not present, it is checked at 405 if the outages are required to be created. If required, the outages are created at 406. After the outages are created, the outage notifications are sent to all the application users. The outage notifications are sent for outage creation, update, and closure. Thereafter, the displayed outages or the created outages are mapped to the incident and service requests at 408. The SLA values are calculated corresponding to the incident and service requests at 410. Various reports are generated based on the calculated SLA values corresponding to the incident and service requests at 412. Examples of reports include, but are not limited to, a SLA report, a performance report, a shift report, an availability report, and a script report. The reports can be viewed by team leads and managers.

In accordance with an embodiment of the present invention, both scheduled and unscheduled outages can be handled by IOS³. The scheduled outages come into picture when planned maintenance activities or releases are there. On the contrary, the unscheduled outages come into picture when an application goes down due to user load scenarios. Both the scheduled and unscheduled outages can be created manually. However, auto creation of outages is also possible when IOS³ is integrated with monitoring tools. In that scenario, outages are automatically created based on alerts from monitoring tools integrated with IOS³.

FIG. 5 is a flow diagram illustrating the assignment of the plurality of incident and service requests to the users available in the shift. Shift management helps in shift handling of operations in production support. The users available are allocated to the shift at 502. The allocated users in the shift are displayed based on the configurations stored in Configuration Database 712 at 504. For example, for every CI, the queues are mapped in Configuration Database 712. The users in turn are mapped to the queues. When an incident is initiated, the incident is assigned to one of the queues based on the selected CI. The incident can be assigned to the users available in the shift and mapped to the same queue to which the CI of the incident is mapped.

A person ordinarily skilled in the art will understand that if the incident remains unresolved, the incident can be handled by the users present in the next shift and mapped to same queue to which the CI of the incident is mapped.

FIG. 6 is a flow diagram illustrating the detailed steps of the process of implementing the plurality of solutions corresponding to the plurality of incident and service requests. At 602, the solutions are retrieved from Knowledge Database 714 if the solutions exist in Knowledge Database 714. In accordance with an embodiment of the present invention, retrieving of the solutions from Knowledge Database 714 is either done automatically or manually by the application users. In manual approach, the application users retrieve the solutions using different keywords. The solutions from Knowledge Database 714 are populated based on the CI selected corresponding to the incident and service requests. It helps reduce rework on similar incidents and makes the resolution process faster. The solutions retrieved from Knowledge Database 714 are displayed at 604. One of the solutions from the plurality of solutions available at 604 is selected at 606.

At 608, the solutions are created by the users available in the shift corresponding to the incident and service requests if the solutions do not exist in Knowledge Database 714. Thereafter, the solutions created by the users available in the shift are reviewed by the domain expert at 610. A list of domain experts and technologies are maintained in Configuration Database 712. They are mapped based on the CI selected corresponding to the incident and service requests. At 612, the solutions are checked for the approved or rejected status by the domain expert. The solutions approved by the domain expert are published at 616, while the solutions rejected by the domain expert are flagged at 614. Publishing or flagging the solutions helps to filter irrelevant information from Knowledge Database 714.

At 618, it is checked whether scripts exist corresponding to the solutions. If the scripts exist, they are executed from one or more servers at 620. Examples of scripts include, but are not limited to, a shell script and a batch script. The solutions are mapped corresponding to the incident and service requests based on the selected CI. Further, the scripts are mapped to the solutions. The scripts are executed remotely from the one or more servers without an agent being installed on the one or more servers.

In accordance with an embodiment of the present invention, an auto closure of an incident is possible when IOS³ is integrated with monitoring tools. For example, an incident is created for server down on reading an alert from the monitoring tools. The incident is then mapped to a solution on a server. The solution involves the execution of a server startup script remotely from a server. After the script is executed, the incident can be closed automatically which was initiated based on the alert from the monitoring tools.

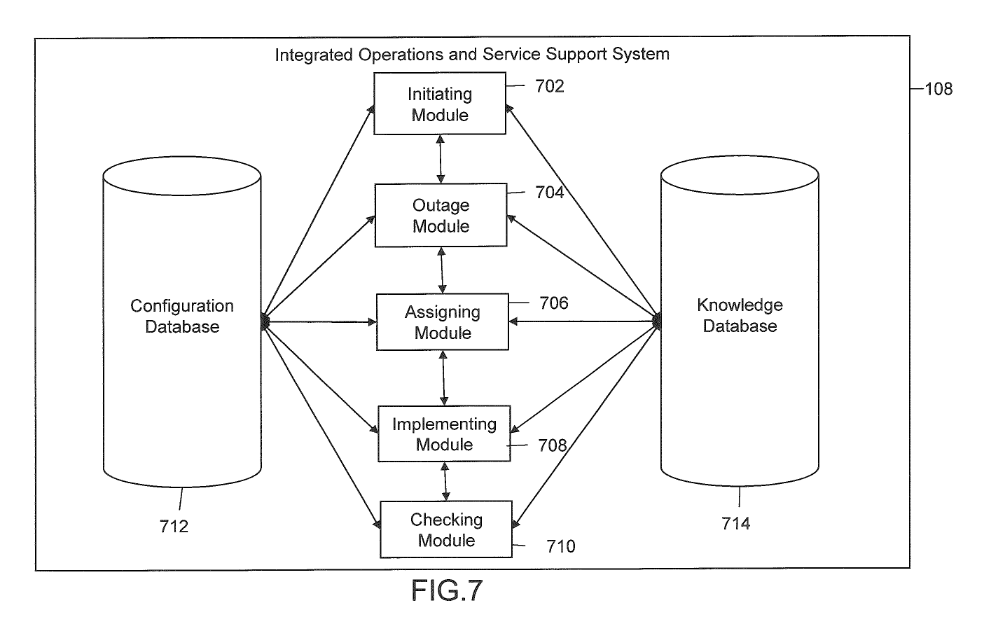

FIG. 7 is a block diagram illustrating the elements of IOS³ 108 used to process the plurality of incident and service requests, in accordance with an embodiment of the present invention. FIG. 7 includes Initiating Module 702, Outage Module 704, Assigning Module 706, Implementing Module 708, Checking Module 710, Configuration Database 712, and Knowledge Database 714.

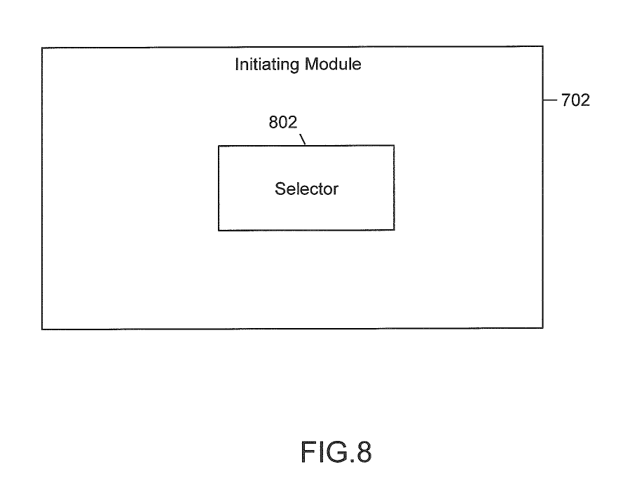

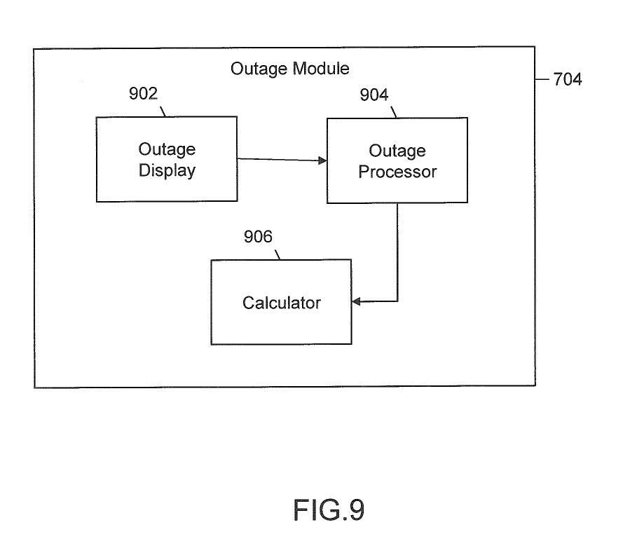

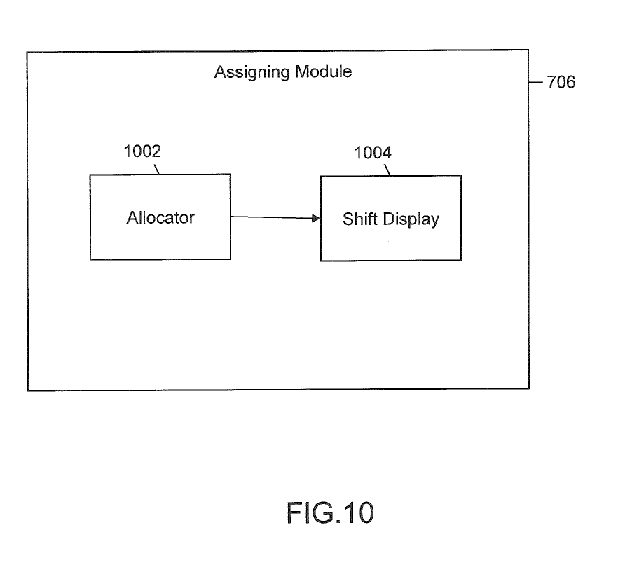

Initiating Module 702 is configured to initiate the incident and service requests. Initiating Module 702 is described in more detail in conjunction with FIG. 8. Once the incident and service requests have been initiated, Outage Module 704 is configured to check the outages corresponding to the incident and service requests. Outage Module 704 is described in more detail in conjunction with FIG. 9. The incident and service requests need to be resolved by assigning it to the users available in the shift. The users available in the shift provide a plurality of solutions. Assigning Module 706 is configured to assign the incident and service requests to the users available in the shift. Assigning Module 706 is described in more detail in conjunction with FIG. 10.

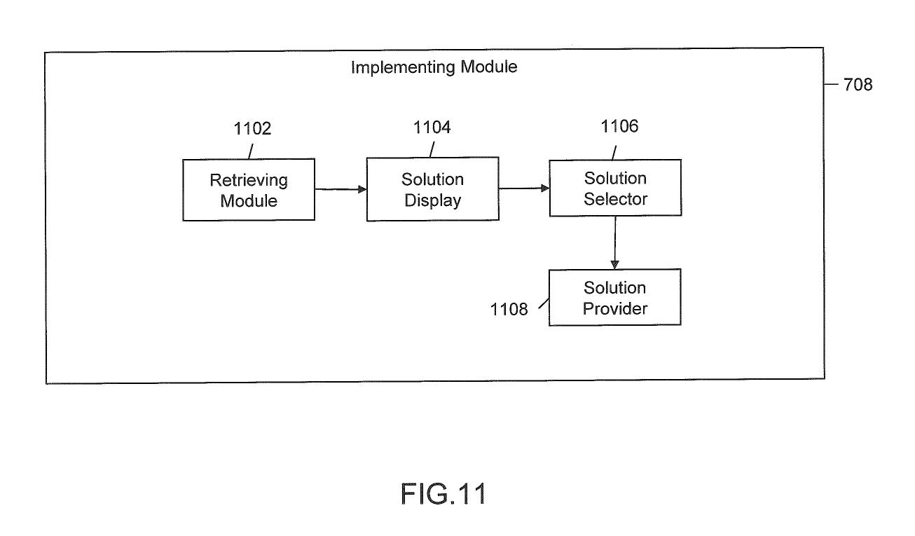

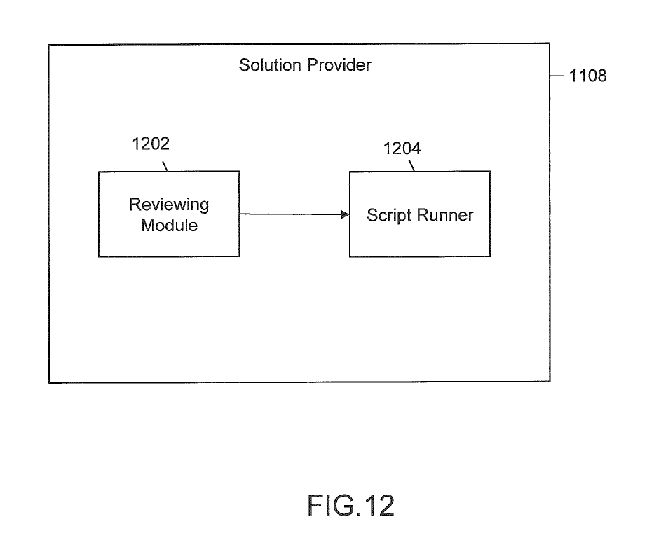

Implementing Module 708 is configured to implement the solutions. In accordance with an embodiment of the present invention, the solutions are either retrieved from Knowledge Database 714 if they exist, else they are created by the users available in the shift. Implementing Module 708 is described in more detail in conjunction with FIG. 11 and FIG. 12.

Checking Module 710 is configured to perform various checks on the checklist prior to closing the incident and service requests. Checking Module 710 ensures that prior to the closure of the incident and service requests, Knowledge Database 714 is updated so that all solutions are captured. This in turn reduces the effort on the resolution of similar incident and service requests.

FIG. 8 is a block diagram illustrating the elements of Initiating Module 702 used to initiate the incident and service requests. Initiating Module 702 includes Selector 802. Selector 802 is configured to select various parameters corresponding to the incident and service requests. Examples of parameters include, but are not limited to, an application name, a version number, a deployment identification number, and a ticket category. The parameters are hereinafter referred to as configuration item (CI).

Selector 802 is further configured to map the selected CI to various configurations from Configuration Database 712. Examples of configurations include, but are not limited to, a plurality of queues, a Service Level Agreement (SLA), a ticket category mapping, and a domain expert.

FIG. 9 is a block diagram illustrating the elements of Outage Module 704 used to check the outages corresponding to the plurality of incident and service requests. Outage Module 704 includes Outage Display 902, Outage Processor 904, and Calculator 906. Initially, it is checked if the outages are present corresponding to the incident and service requests. Outage Display 902 is configured to display the outages if the outages are present. Outage processor 904 is configured to create outages if the outages are not present and are required to be created. Thereafter, the outages are mapped to the incident and service requests by Outage Processor 904. After the outages are created, the outage notifications are sent to the application users. Outage Processor 904 is also configured to send the outage notifications for outage creation, update, and closure.

Calculator 906 is configured to calculate the SLA values corresponding to the incident and service requests. Calculator 906 is further configured to generate various reports based on the calculated SLA values corresponding to the incident and service requests.

FIG. 10 is a block diagram illustrating the elements of Assigning Module 706 used to assign the plurality of incident and service requests to the users available in the shift. Assigning Module 706 includes Allocator 1002 and Shift Display 1004. When an incident is initiated, the incident is assigned to one of the queues based on the selected CI. The incident can be assigned to the users available in the shift and mapped to same queue to which the CI of the incident is mapped. Mappings are stored in Configuration Database 712. Allocator 1002 is configured to allocate the users to the shift. Shift Display 1004 is configured to display the allocated users in the shift based on the mappings stored in Configuration Database 712.

FIG. 11 is a block diagram illustrating the elements of Implementing Module 708 used to implement the plurality of solutions corresponding to the plurality of incident and service requests. Implementing Module 708 includes Retrieving Module 1102, Solution Display 1104, Solution Selector 1106, and Solution Provider 1108. Retrieving Module 1102 is configured to retrieve the solutions from Knowledge Database 714 if the solutions exist in Knowledge Database 714. In accordance with an embodiment of the present invention, Retrieving Module 1102 is further configured to retrieve the solutions from Knowledge Database 714 automatically or manually. Manual mode involves the use of one or more keywords. Retrieving Module 1102 retrieves the solutions from Knowledge Database 714 based on the selected CI corresponding to the incident and service requests. Solution Display 1104 is configured to display the solutions retrieved from Knowledge Database 714. Solution Selector 1106 is configured to select one of the displayed solutions. Solution Provider 1108 is configured to create the solutions corresponding to the incident and service requests if the solutions do not exist in Knowledge Database 714. Solution Provider 1108 is described in more detail in conjunction with FIG. 12.

FIG. 12 is a block diagram illustrating the elements of Solution Provider 1108. Solution Provider 1108 includes Reviewing Module 1202 and Script Runner 1204. Reviewing Module 1202 is configured to review the solutions created corresponding to the incident and service requests by the domain expert. The list of domain experts exists in Configuration Database 712. They are mapped based on the selected CI corresponding to the incident and service requests. Reviewing Module 1202 is configured to publish the solutions if they are approved by the domain expert and flag the solutions if they are rejected by the domain expert. Script Runner 1204 is configured to execute the scripts from the one or more servers if the scripts exist corresponding to the solutions. Thereafter, the scripts are mapped to the solutions. The solutions are mapped corresponding to the incident and service requests based on the selected CI. The scripts are executed remotely from the one or more servers without an agent being installed on the one or more servers.

In accordance with an embodiment of the present invention, the present invention provides a method for processing a plurality of incident and service requests. The present invention integrates the management of incident, configuration, knowledge, shift, outage, and various other management processes. The method first initiates the incident and service requests. The outages are checked corresponding to the incident and service requests. If the outages exist, they are displayed and mapped to the incident and service requests. If the outages do not exist, they are created if required, mapped, and the outage notifications corresponding to the incident and service requests are sent to the application users. The incident and service requests are assigned to the users available in the shift for the solutions. If the solutions corresponding to the incident and service requests exist in the knowledge database, they are implemented. If the solutions corresponding to the incident and service requests do not exist in the knowledge database, they are created by the users available in the shift. The created solutions are then published or flagged after they are reviewed by the domain expert. Various checks are performed based on the checklist prior to closure of the incident and service requests. The advantage of the method is that it saves the effort to resolve similar incident and service requests, and hence process efficiency is increased.

The system for processing a plurality of incident and service requests, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit, and the network interface modules for connecting with the Internet. The computer further comprises a microprocessor, which is connected to a communication bus. The computer also includes a memory, which may include Random Access Memory (RAM) and Read Only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN), and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for processing a plurality of incident and service requests. The computer program product includes a computer usable medium having a set program instructions comprising a program code for processing a plurality of incident and service requests. The set of instructions may include various commands that instruct the processing machine to perform specific tasks such as the steps that constitute the method of the present invention. The set of instructions may be in the form of a software program. Further, the software may be in the form of a collection of separate programs, a program module with a large program, or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions, and equivalents will be apparent to those skilled in the art without departing from the spirit and scope of the invention, as described in the claims.

1. A method for processing a plurality of incident and service requests, the method comprising:
a. initiating the plurality of incident and service requests;
b. checking one or more outages corresponding to the plurality of incident and service requests;
c. assigning the plurality of incident and service requests to one or more users available in a shift; and
d. implementing a plurality of solutions corresponding to the plurality of incident and service requests.

2. The method according to claim 1, wherein initiating the plurality of incident and service requests comprises:
a. selecting one or more parameters corresponding to the initiated plurality of incident and service requests; and
b. mapping one or more configurations from a configuration database based on the selected one or more parameters.

3. The method according to claim 2, wherein the one or more parameters comprises an application name, a version number, a deployment identification number, and a ticket category.

4. The method according to claim 2, wherein the one or more configurations from the configuration database comprises a plurality of queues, a Service Level Agreement (SLA), a ticket category mapping, and a domain expert.

5. The method according to claim 1, wherein checking the one or more outages corresponding to the plurality of incident and service requests comprises:
a. displaying the one or more outages when the one or more outages are present corresponding to the plurality of incident and service requests;
b. creating the one or more outages when the one or more outages are not present corresponding to the plurality of incident and service requests; and
c. mapping the one or more outages corresponding to the plurality of incident and service requests.

6. The method according to claim 5, wherein creating the one or more outages when the one or more outages are not present corresponding to the plurality of incident and service requests comprises sending one or more outage notifications to a plurality of application users.

7. The method according to claim 5 further comprising calculating one or more Service Level Agreement (SLA) values corresponding to the plurality of incident and service requests.

8. The method according to claim 7, wherein calculating the one or more SLA values corresponding to the plurality of incident and service requests comprises generating a plurality of reports based on the calculated one or more SLA values.

9. The method according to claim 1, wherein assigning the plurality of incident and service requests to the one or more users available in the shift comprises:
a. allocating the one or more users to the shift; and
b. displaying the allocated one or more users in the shift based on one or configurations stored in a configuration database, the one or more configurations being mapped based on one or more parameters selected during initialization of the plurality of incident and service requests.

10. The method according to claim 1, wherein implementing the plurality of solutions corresponding to the plurality of incident and service requests comprises:
a. retrieving the plurality of solutions from a knowledge database based on one or more parameters selected during initialization of the plurality of incident and service requests when the plurality of solutions exist in the knowledge database;
b. displaying the plurality of solutions retrieved from the knowledge database;
c. selecting one of the plurality of displayed solutions; and
d. creating the plurality of solutions by the assigned one or more users available in the shift corresponding to the plurality of incident and service requests when the plurality of solutions does not exist in the knowledge database.

11. The method according to claim 10, wherein retrieving the plurality of solutions from the knowledge database comprises retrieving the plurality of solutions from the knowledge database automatically.

12. The method according to claim 10, wherein retrieving the plurality of solutions from the knowledge database comprises retrieving the plurality of solutions from the knowledge database manually by a plurality of application users based on one or more keywords.

13. The method according to claim 10, wherein creating the plurality of solutions by the assigned one or more users corresponding to the plurality of incident and service requests comprises:
a. reviewing the plurality of solutions by a domain expert;
b. publishing the plurality of solutions when the plurality of solutions being approved by the domain expert; and
c. flagging the plurality of solutions when the plurality of solutions being rejected by the domain expert.

14. The method according to claim 13 further comprising executing a plurality of scripts without an agent being installed on one or more servers when the plurality of scripts exist corresponding to the plurality of solutions.

15. The method according to claim 1 further comprising performing one or more checks based on a checklist for closing the plurality of incident and service requests.

16. The method according to claim 15, wherein performing the one or more checks based on the checklist for closing the plurality of incident and service requests comprises updating the plurality of solutions in a knowledge database.

17. A system for processing a plurality of incident and service requests, the system comprising:
a. an initiating module for initiating the plurality of incident and service requests;
b. an outage module for checking one or more outages corresponding to the plurality of incident and service requests;
c. an assigning module for assigning the plurality of incident and service requests to one or more users available in a shift; and
d. an implementing module for implementing a plurality of solutions corresponding to the plurality of incident and service requests.

18. The system according to claim 17, wherein the initiating module comprises:
a. a selector configured to:
i. select one or more parameters corresponding to the initiated plurality of incident and service requests; and
ii. map one or more configurations from a configuration database based on the selected one or more parameters.

19. The system according to claim 18, wherein the one or more parameters comprises an application name, a version number, a deployment identification number, and a ticket category.

20. The system according to claim 18, wherein the one or more configurations from the configuration database comprises a plurality of queues, a Service Level Agreement (SLA), a ticket category mapping, and a domain expert.

21. The system according to claim 17, wherein the outage module comprises:
a. an outage display for displaying the one or more outages when the one or more outages are present corresponding to the plurality of incident and service requests; and
b. an outage processor configured to:
i. create the one or more outages when the one or more outages are not present corresponding to the plurality of incident and service requests; and
ii. map the one or more outages corresponding to the plurality of incident and service requests.

22. The system according to claim 21, wherein the outage processor is further configured to send one or more outage notifications to a plurality of application users.

23. The system according to claim 21 further comprising a calculator configured to calculate one or more Service Level Agreement (SLA) values corresponding to the plurality of incident and service requests.

24. The system according to claim 23, wherein the calculator is further configured to generate a plurality of reports based on the calculated one or more SLA values.

25. The system according to claim 17, wherein the assigning module comprises:
a. an allocator configured to allocate the one or more users to the shift; and
b. a shift display configured to display the allocated one or more users in the shift based on one or configurations stored in a configuration database, the one or more configurations being mapped based on one or more parameters selected during initialization of the plurality of incident and service requests.

26. The system according to claim 17, wherein the implementing module comprises:
a. a retrieving module configured to retrieve the plurality of solutions from a knowledge database based on one or more parameters selected during initialization of the plurality of incident and service requests when the plurality of solutions exist in the knowledge database;
b. a solution display configured to display the plurality of solutions retrieved from the knowledge database;
c. a solution selector configured to select one of the plurality of displayed solutions; and
d. a solution provider configured to create the plurality of solutions by the assigned one or more users available in the shift corresponding to the plurality of incident and service requests when the plurality of solutions does not exist in the knowledge database.

27. The system according to claim 26, wherein the retrieving module is further configured to retrieve the plurality of solutions from the knowledge database automatically.

28. The system according to claim 26, wherein the retrieving module is further configured to retrieve the plurality of solutions from the knowledge database manually based on one or more keywords.

29. The system according to claim 26, wherein the solution provider comprises:
a. a reviewing module configured to:
i. review the plurality of solutions by a domain expert;
ii. publish the plurality of solutions when the plurality of solutions being approved by the domain expert; and
iii. flag the plurality of solutions when the plurality of solutions being rejected by the domain expert.

30. The system according to claim 29 further comprising a script runner configured to execute a plurality of scripts without an agent being installed on one or more servers when the plurality of scripts exist corresponding to the plurality of solutions.

31. The system according to claim 17 further comprising a checking module configured to perform one or more checks based on a checklist for closing the plurality of incident and service requests.

32. The system according to claim 31, wherein the checking module is further configured to update the plurality of solutions in a knowledge database.

33. A computer program product for use with a computer, the computer program product comprising instructions stored in a computer usable medium having a computer readable program code embodied therein for processing a plurality of incident and service requests, the instructions comprising:
a. program instructions for initiating the plurality of incident and service requests;
b. program instructions for checking one or more outages corresponding to the plurality of incident and service requests;
c. program instructions for assigning the plurality of incident and service requests to one or more users available in a shift; and
d. program instructions for implementing a plurality of solutions corresponding to the plurality of incident and service requests.
